(19) United States
(12) Patent Application Publication
(10) Pub. No.: US 2021/0012258 A1
(43) Pub. Date: Jan. 14, 2021

(54) AIRPORT LOGISTICS MANAGEMENT SYSTEM

(71) Applicant: TOYOTA JIDOSHA KABUSHIKI KAISHA, Toyota-shi (JP)

(72) Inventors: Ikuo Ohta, Toyota-shi (JP); Hideshi Mizutani, Toyota-shi (JP); Atsushi Sajiki, Okazaki-shi (JP); Takao Inata, Setagaya-ku (JP); Yohei Tanigawa, Toyota-shi (JP); Atsushi Nakajima, Kariya-city (JP); Atsuo Komatsubara, Nagakute-shi (JP)

(21) Appl. No.: 16/922,238

(22) Filed: Jul. 7, 2020

(30) Foreign Application Priority Data
Jul. 8, 2019 (JP) 2019-126725

(51) Int. Cl. G06Q 10/06; G06Q 50/30

(52) U.S. Cl. CPC G06Q 10/06313; G06Q 10/063114; G06Q 50/30

(57) ABSTRACT

An airport logistics management system capable of reducing working resources in logistics in an airport is provided. The airport logistics management system includes: a collection unit configured to collect departure and arrival information, information regarding accommodation capacities of departing and arriving flights, and information regarding a record of past amounts of loads; a prediction unit configured to predict a workload in logistics at the airport based on the information collected by the collection unit; and a determination unit configured to determine an amount of working resources that are necessary based on the workload predicted by the prediction unit.

### CROSS REFERENCE TO RELATED APPLICATIONS

This application is based upon and claims the benefit of priority from Japanese patent application No. 2019-126725, filed on Jul. 8, 2019, the disclosure of which is incorporated herein in its entirety by reference.

### BACKGROUND

The present disclosure relates to an airport logistics management system.

Techniques for improving efficiency of logistics in airports have been under discussion. Japanese Unexamined Patent Application Publication No. 2002-321699 discloses a technique for connecting an air cargo holding area in an airport terminal building with an aircraft parking area by an air cargo conveyor mechanism provided underground and further connecting the ground level and a loading/unloading position for the air cargo conveyor mechanism by means of air cargo elevators, thereby conveying air cargo underground.

### SUMMARY

The workload of logistics in an airport has been predicted, for example, artificially and thus the accuracy thereof has not been very high. If the number of working vehicles and the number of workers that are necessary for the logistics job in the airport are determined based on the prediction of the workload whose accuracy is not very high, it is possible that the number of working vehicles or the number of workers may become insufficient at a peak time. Therefore, in an airport, excessive numbers of working vehicles and workers need to be secured. Further, currently, each airline company outsources the logistics work separately to a logistics company with which the airline company collaborates, which means each logistics company needs to secure a number of working vehicles sufficient to deal with the workload at the peak time of the airline company which outsources its logistics work. Therefore, there is a problem that the number of excessive working vehicles in the airport further increases.

The present disclosure has been made in view of the aforementioned background and aims to provide an airport logistics management system capable of reducing working resources in the logistics in the airport.

An airport logistics management system according to one embodiment of the present disclosure includes: a collection unit configured to collect departure and arrival information, information regarding accommodation capacities of departing and arriving flights, and information regarding a record of past amounts of loads; a prediction unit configured to predict a workload in logistics at an airport based on the information collected by the collection unit; and a determination unit configured to determine working resources based on the workload predicted by the prediction unit.

In the airport logistics management system according to one embodiment of the present disclosure, the workload in the logistics in the airport is predicted based on the departure and arrival information, the information regarding the accommodation capacities of departing and arriving flights, and the information regarding the record of the past amounts of loads, whereby it is possible to improve the accuracy of predicting the workload. The working resources required in each of the logistics companies are determined by predicting the workload with a high accuracy. Therefore, the working resources in the logistics in the airport can be reduced compared to a case in which the working resources are determined by predicting the workload with a low accuracy such as a case in which the workload is predicted artificially.

Further, the working resources may be the number of working vehicles and the number of workers. The number of working vehicles and the number of workers that are necessary in each logistics company is determined by predicting the workload with a high accuracy, whereby the number of working vehicles and the number of workers can be reduced.

Further, the determination unit may further determine arrangement of the working vehicles based on the workload predicted by the prediction unit. By determining the arrangement of each of the working vehicles by predicting the workload with a high accuracy, it is possible to improve the operation efficiency in the logistics work.

Further, the collection unit may collect, from a terminal of each airline company, each of the departure and arrival information, the information regarding accommodation capacities of departing and arriving flights, and the information regarding the record of the past amounts of loads.

Further, the determination unit may notify a terminal of a resource management company that collectively manages working resources of results of determining the amount of the working resources.

According to the present disclosure, it is possible to reduce working resources in the logistics in an airport.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration of an airport logistics management system according to an embodiment;

FIG. 2 is a flowchart showing a flow of processing in the airport logistics management system according to the embodiment;

FIG. 3 is a schematic view showing one example of a logistics operation that uses the airport logistics management system according to the embodiment; and

FIG. 4 is a table showing one example of results of determining working resources in a determination unit of the airport logistics management system according to the embodiment.

### DESCRIPTION OF EMBODIMENTS

Hereinafter, the present disclosure will be described based on the following embodiment. However, the disclosure set forth in claims is not limited to the following embodiment. Moreover, it is not absolutely necessary to provide all the configurations to be described in the following embodiment as means for solving the problems. The following descriptions and the drawings are omitted and simplified as appropriate for the sake of clarity of description. Throughout the drawings, the same elements are denoted by the same reference symbols, and overlapping descriptions are omitted as appropriate.

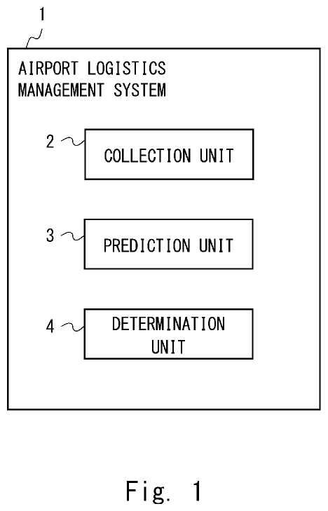

First, a configuration of an airport logistics management system according to the embodiment will be described. FIG. 1 is a block diagram showing a configuration of an airport logistics management system 1. As shown in FIG. 1, the airport logistics management system 1 includes a collection unit 2, a prediction unit 3, and a determination unit 4.

The collection unit 2 collects departure and arrival information, information regarding accommodation capacities of departing and arriving flights, and information regarding a record of past amounts of loads. The prediction unit 3 predicts the workload in the logistics in an airport based on the information collected by the collection unit 2. The determination unit 4 determines the amount of working resources that are necessary based on the workload predicted by the prediction unit 3. The amount of the working resources is, for example, the number of working vehicles or the number of workers.

Next, a flow of processing in the airport logistics management system 1 will be described below. In the following description, FIG. 1 is also referred to as appropriate.

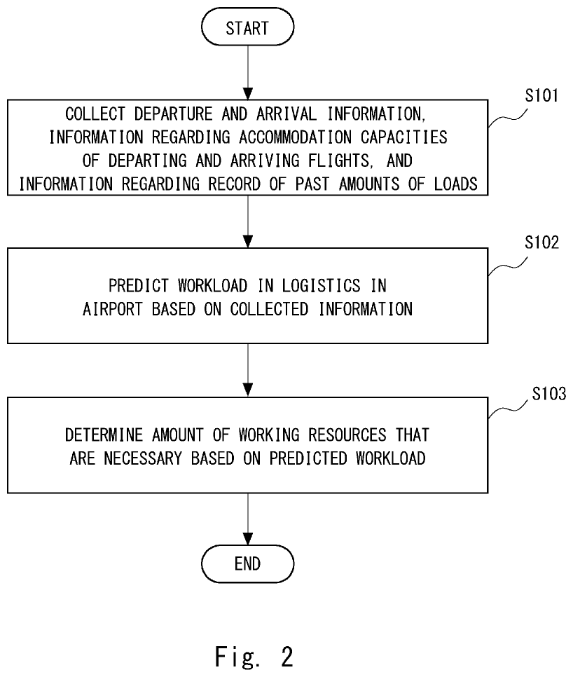

FIG. 2 is a flowchart showing a flow of processing in the airport logistics management system 1. As shown in FIG. 2, first, the collection unit 2 collects the departure and arrival information, the information regarding the accommodation capacities of the departing and arriving flights, and the information regarding the record of the past amounts of loads (Step S101). Next, the prediction unit 3 predicts the workload in the logistics in the airport based on the collected information (Step S102). Next, the determination unit 4 determines the amount of working resources that are necessary based on the predicted workload (Step S103).

Next, effects of reducing the amount of the working resources by use of the airport logistics management system 1 according to this embodiment will be described.

The workload of the logistics in an airport has been predicted, for example, artificially and thus the accuracy thereof has not been very high. If the amount of working resources (the number of working vehicles, the number of workers, etc.) that are necessary for the logistics job in the airport is determined based on the prediction of the workload whose accuracy is not very high, it is possible that the number of working vehicles or the number of workers may become insufficient at a peak time. Therefore, an excessive amount of working resources need to be secured in the airport.

The larger the amounts of the loads handled in the airport become, the larger the workload in the logistics in the airport becomes. In general, when the number of departing and arriving flights becomes large, the amounts of loads become larger than that in a case in which the number of departing and arriving flights is small. Further, when the accommodation capacities of the departing and arriving flights become large, the amounts of loads become larger than that in a case in which the accommodation capacities are small. Further, it is generally considered that the current amounts of loads have a correlation with the previous amounts of loads in the same period. When, for example, the record of the amounts of loads last year shows that the respective amounts of loads in January, March, May, July, August, and December are relatively large and the respective amounts of loads in February, April, June, September, October, and November are relatively small, it can be considered that the amounts of loads this year in the months corresponding to the above months in last year will tend to be similar to each other. Therefore, the amounts of loads handled in the airport can be estimated from the departure and arrival information, the information regarding the accommodation capacities of the departing and arriving flights, and the information regarding the record of the past amounts of loads.

In the airport logistics management system 1 according to this embodiment, the workload in the logistics in the airport is predicted based on the departure and arrival information, the information regarding the accommodation capacities of the departing and arriving flights, and the information regarding the record of the past amounts of loads. It is therefore possible to improve the accuracy of predicting the workload. Then the amount of the working resources required in each logistics company is determined by predicting the workload with a high accuracy, whereby it is possible to reduce the amount of the working resources in the logistics in the airport.

The determination unit 4 shown in FIG. 1 may further determine arrangement of the working vehicles based on the workload predicted by the prediction unit 3. By predicting the workload with a high accuracy, the number of working vehicles that are necessary for each logistics job conducted in the airport can be known, whereby it is possible to determine in which working place each of the working vehicles should be arranged. By arranging the respective working vehicles in places where it is planned to perform working, it is possible to improve the operation efficiency in the logistics work.

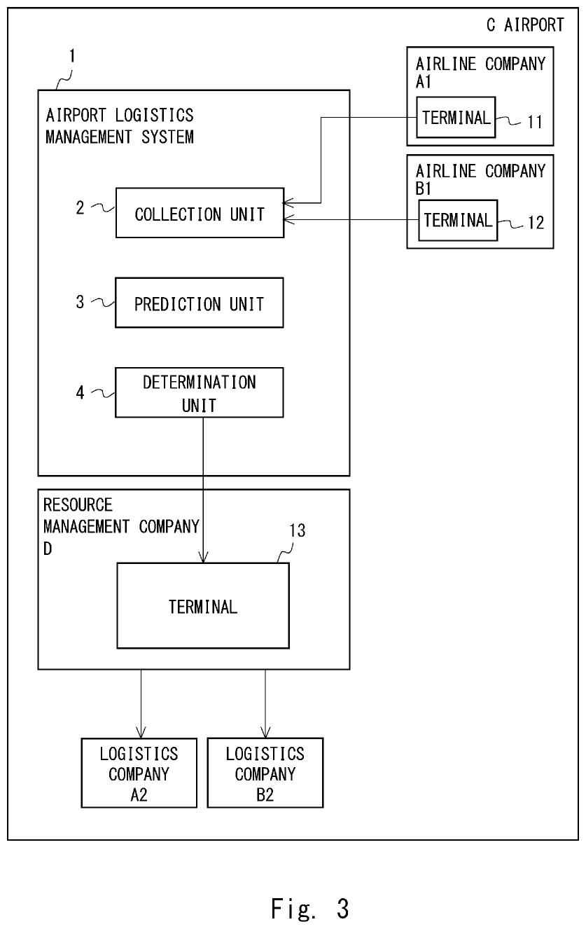

FIG. 3 is a schematic view showing one example of the logistics operation that uses the airport logistics management system 1 according to this embodiment. Assume a case, for example, where an airline company A1 (including an airline company collaborating with the airline company A1) and an airline company B1 (including an airline company collaborating with the airline company B1) arrive at or depart from a C airport. It is further assumed that the logistics work of the airline company A1 is undertaken by the logistics company A2 and the logistics work of the airline company B1 is undertaken by the logistics company B2.

As shown in FIG. 3, the collection unit 2 collectively collects the number of departing and arriving flights, the accommodation capacity of the load of each of the departing and arriving flights, and the information regarding the record of the past amounts of loads from each of a terminal 11 of the airline company A1 and a terminal 12 of the airline company B1. Then the determination unit 4 collectively determines the amount of the working resources required in the logistics companies A2 and B2 and notifies a terminal 13 of a resource management company D of the results of determining the amount of the working resources. The resource management company D allocates the working resources to the management company A2 and the management company B2 in accordance with the results of the determination. The accommodation capacity of the load of each of the departing and arriving flights and the information regarding the record of the past amounts of loads in each airline company are highly confidential. Therefore, some measures are taken to keep confidentiality of the information in the airport logistics management system 1 and the resource management company D.

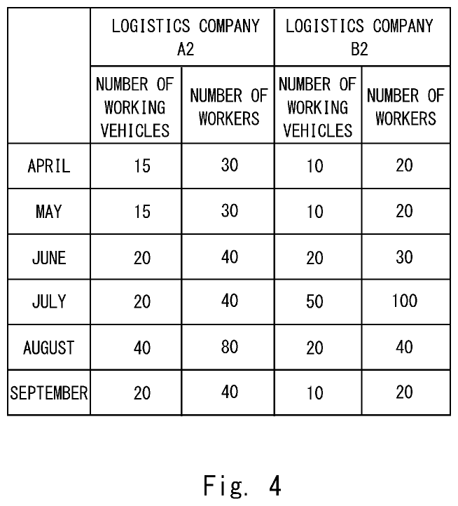

FIG. 4 is a table showing one example of the results of determining the amount of the working resources in the determination unit 4 (see FIG. 3) of the airport logistics management system. FIG. 4 shows the number of working vehicles and the number of workers that are necessary in each month of the first half of the year (from April to September) of each of the logistics companies (the logistics companies A2 and B2). As shown in FIG. 4, in the logistics company A2, the number of working vehicles that are necessary is the largest in August, namely 40. On the other hand, in the logistics company B2, the number of working vehicles that are necessary is the largest in July, namely 50. Further, the total number of working vehicles that are necessary in the logistics companies A2 and B2 is the largest in July, namely 70.

If each of the logistics companies secures the number of working vehicles that are sufficient to cope with situations at the peak time, the logistics company A2 secures 40 working vehicles and the logistics company B2 secures 50 working vehicles. That is, 90 working vehicles in total are held in the airport. On the other hand, in the logistics operation that uses the airport logistics management system 1 according to this embodiment (see FIG. 3), the resource management company D collectively manages the working resources and allocates the necessary working resources to the respective logistics companies in accordance with the results of the determination made by the determination unit 4. Therefore, it is sufficient that only 70 working vehicles, which is equal to the largest total number of working vehicles that are necessary for each of the logistics companies A2 and B2 (July), be held in the airport. That is, compared to the case in which each of the logistics companies secures the number of working vehicles that are sufficient to cope with situations at the peak time, the number of working vehicles held in the airport can be reduced by 20.

It can be considered that the case of the number of workers is the same as that of the aforementioned case of the number of the working vehicles. That is, by having all the workers who engage in the logistics work belong to the resource management company D and having the resource management company D send the required workers to each of the logistics companies A2 and B2, it is possible to further reduce any excess number of workers.

Note that the present disclosure is not limited to the above embodiment and may be changed as appropriate without departing from the spirit of the present disclosure.

For example, in the above-described embodiments, the airport logistics management system according to the present disclosure has been described as a hardware configuration, but the present disclose is not limited thereto. In the present disclosure, any processing of the airport logistics management system can be achieved by a processor, such as a CPU (Central Processing Unit), loading and executing a computer program stored in a memory.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An airport logistics management system comprising:
a collection unit configured to collect departure and arrival information, information regarding accommodation capacities of departing and arriving flights, and information regarding a record of past amounts of loads;
a prediction unit configured to predict a workload in logistics at an airport based on the information collected by the collection unit; and
a determination unit configured to determine an amount of working resources that are necessary based on the workload predicted by the prediction unit.

2. The airport logistics management system according to claim 1, wherein the amount of the working resources is the number of working vehicles and the number of workers.

3. The airport logistics management system according to claim 2, wherein the determination unit further determines arrangement of the working vehicles based on the workload predicted by the prediction unit.

4. The airport logistics management system according to claim 1, wherein the collection unit collects, from a terminal of each airline company, each of the departure and arrival information, the information regarding the accommodation capacities of the departing and arriving flights, and the information regarding the record of the past amounts of loads.

5. The airport logistics management system according to claim 1, wherein the determination unit notifies a terminal of a resource management company that collectively manages working resources of results of determining the amount of the working resources.
